(19) United States
(12) Patent Application Publication
(10) Pub. No.: US 2025/0124318 A1
(43) Pub. Date: Apr. 17, 2025

(54) METHOD FOR DECOMPOSING MPMCT GATE IN QUANTUM CIRCUIT

(71) Applicant: ELECTRONICS AND TELECOMMUNICATIONS RESEARCH INSTITUTE, Daejeon (KR)

(72) Inventor: Jong-Heon LEE, Seoul (KR)

(73) Assignee: ELECTRONICS AND TELECOMMUNICATIONS RESEARCH INSTITUTE, Daejeon (KR)

(21) Appl. No.: 18/627,870

(22) Filed: Apr. 5, 2024

(30) Foreign Application Priority Data
Oct. 12, 2023 (KR) 10-2023-0135563

(51) Int. Cl. G06N 10/20

(52) U.S. Cl. CPC G06N 10/20

(57) ABSTRACT

Disclosed herein are a method for decomposing a Mixed Polarity Multiple Controlled Toffoli (MPMCT) gate in a quantum circuit and a quantum circuit designed using the method. The method includes dividing a process of decomposing an MPMCT gate in a quantum circuit into a front step, a central step, and a back step, selecting one of multiple decomposition methods in consideration of the sub-MCT gate assigned to each of the steps and the number (k) of work qubits of which the initial states are known (Clean Work Qubits (CWQs)), and decomposing the MPMCT gate into gates of a Clifford+T set, which is a standard fault-tolerant gate set, by applying the selected decomposition method.

### CROSS REFERENCE TO RELATED APPLICATION

This application claims the benefit of Korean Patent Application No. 10-2023-0135563, filed Oct. 12, 2023, which is hereby incorporated by reference in its entirety into this application.

### BACKGROUND OF THE INVENTION

### 1. Technical Field

The present disclosure relates generally to technology for efficiently decomposing a Mixed Polarity Multiple Controlled Toffoli (MPMCT) gate in a quantum circuit, and more particularly to technology for efficiently decomposing an MPMCT gate, which is one of representative composite gates, into Toffoli gates when a Fault-Tolerant Quantum Computation (FTQC) is considered at the logical level of a quantum circuit.

### 2. Description of the Related Art

Mixed Polarity Multiple Controlled Toffoli (MPMCT) gates are used in various algorithms proposed in quantum computing, such as a Grover's algorithm, a quantum random walk algorithm, and the like. Depending on how efficiently these MPMCT gates are designed, quantum algorithms may be efficiently implemented.

One of previous techniques proposes two detailed methods that respectively use Clean Work Qubits (CWQs) and Dirty Borrowed Qubits (DBQs), which are two types of work qubits, rather than considering the CWQs and the DBQs at once. When another one of the previous techniques is used, a logical error in which an inefficient circuit is implemented in spite of an increase in the number of provided CWQs occurs.

### Documents of Related Art

(Patent Document 1) Korean Patent Application Publication No. 10-2023-0076072, published on May 31, 2023 and titled “Method and apparatus for reducing T-depth of quantum circuit”.

### SUMMARY OF THE INVENTION

An object of the present disclosure is to provide ancilla qubits (work qubits) in a balanced way across an entire quantum circuit, thereby implementing an efficient quantum circuit based on MPMCT gates.

Another object of the present disclosure is to minimize a time cost metric corresponding to a T-depth (Toffoli-depth) in consideration of Fault-Tolerant Quantum Computation (FTQC).

A further object of the present disclosure is to efficiently decompose an MPMCT gate, which is used in various quantum algorithms, thereby more efficiently implementing a quantum algorithm.

In order to accomplish the above objects, a method for decomposing an MPMCT gate in a quantum circuit according to the present disclosure includes dividing a process of decomposing an MPMCT gate in a quantum circuit into a front step, a central step, and a back step, selecting one of multiple decomposition methods in consideration of a sub-MCT gate assigned to each of the steps and the number (k) of work qubits of which the initial states are known (Clean Work Qubits (CWQs)), and decomposing the MPMCT gate into gates of a Clifford+T set, which is a standard fault-tolerant gate set, by applying the selected decomposition method.

Here, dividing the process may include, based on m that is the maximum number of control lines available in the sub-MCT gate assigned to the front step, dividing c control lines used in the MPMCT gate into [c/m] or [c/m]+1 groups; and setting the sub-MCT gate to be assigned to the central step and the number of available work qubits in consideration of the size of the last group (C_{[c/m]} or C_{[c/m]+1}) of the groups.

Here, when the size of the last group (C_{[c/m]+1}) is 0, a sub-MCT gate corresponding to C^{[c/m]}NOT and k−[c/m] work qubits of which the initial states are known (CWQs) may be assigned to the central step.

Here, when the size of the last group (C_{[c/m]+1}) is 1, a sub-MCT gate corresponding to C^{[c/m]+1}NOT and k−[c/m] work qubits of which the initial states are known (CWQs) may be assigned to the central step.

Here, when the size of the last group (C_{[c/m]+1}) is equal to or greater than 2, a sub-MCT gate corresponding to C^{[c/m]+1}NOT and k−[c/m]−1 work qubits of which the initial states are known (CWQs) may be assigned to the central step.

Here, dividing the process may comprise assigning [c/m]C^{m}NOT gates and a single C^{c-m[c/m]+1}NOT gate to the front step.

Here, the front step may include multiple stages, and may be designed recursively such that the value of k−[c/m]−1 becomes equal to or less than [c/m]+1−2 after termination of the corresponding step when the number (k) of work qubits of which the initial states are known (CWQs) is equal to or greater than 4.

Here, the back step may be designed to be performed in the reverse order of the front step.

Here, m, which is the maximum number of control lines available in the sub-MCT gate assigned to the front step, may be set equal to or less than [2c/(k−3)].

Here, selecting one of the multiple decomposition methods may comprise selecting one of the multiple decomposition methods by identifying a first case in which the number (k) of work qubits of which the initial states are known (CWQs) is 0, a second case in which the range of the number (k) of work qubits of which the initial states are known (CWQs) corresponds to 4≥k≥1, a third case in which the range of the number (k) of work qubits of which the initial states are known (CWQs) corresponds to 2[c/3]≥k≥4, a fourth case in which the range of the number (k) of work qubits of which the initial states are known (CWQs) corresponds to c−3≥k≥2[c/3], and a fifth case in which the range of the number (k) of work qubits of which the initial states are known (CWQs) corresponds to k≥c−2.

Here, selecting one of the multiple decomposition methods may comprise selecting a first decomposition method or a second decomposition method in the first case, selecting a third decomposition method or a fifth decomposition method in the second case, selecting the first decomposition method or a fourth decomposition method in the third case, selecting the fourth decomposition method in the fourth case, and selecting the fourth decomposition method in the fifth case.

Here, in the first decomposition method, when n corresponding to ciphertext bits of a sub-MCT gate assigned to a corresponding step is equal to or greater than 3 and when n−2 work qubits of which the initial states are unknown (Dirty Borrowed Qubits (DBQs)) are present, the sub-MCT gate assigned to the corresponding step may be decomposed into a CⁿNOT gate having a Toffoli-depth of 4(n−2), a T-depth of 4(n−1), and a T-count of 12n-20.

Here, in the second decomposition method, when n corresponding to ciphertext bits of a sub-MCT gate assigned to a corresponding step is equal to or greater than 4 and when a single work qubit of which the initial state is unknown (DBQ) is present, the sub-MCT gate assigned to the corresponding step may be decomposed into a CⁿNOT gate having a T-depth of 8n-20.

Here, the third decomposition method may be divided into a 3-1-th decomposition method and a 3-2-th decomposition method depending on whether n corresponding to ciphertext bits of a sub-MCT gate assigned to a corresponding step is an even number or an odd number. In the 3-1-th decomposition method, when n corresponding to the ciphertext bits of the sub-MCT gate assigned to the corresponding step is equal to or greater than 4 and when a single work qubit of which the initial state is known (CWQ) is present, if n is an even number, the sub-MCT gate assigned to the corresponding step may be decomposed into a CⁿNOT gate having a T-depth of 6(n−2). In the 3-2-th decomposition method, when n corresponding to the ciphertext bits of the sub-MCT gate assigned to the corresponding step is equal to or greater than 4 and when a single work qubit of which the initial state is known (CWQ) is present, if n is an odd number, the sub-MCT gate assigned to the corresponding step may be decomposed into a CⁿNOT gate having a T-depth of 6(n−2)-2.

Here, the fourth decomposition method may be divided into a 4-1-th decomposition method, a 4-2-th decomposition method, a 4-3-th decomposition method, and a 4-4-th decomposition method in consideration of the number of work qubits of which the initial states are known (CWQs) and which are assigned to a corresponding step. In the 4-1-th decomposition method, when n corresponding to ciphertext bits of a sub-MCT gate assigned to the corresponding step is equal to or greater than 3 and when n−2 work qubits of which the initial states are known (CWQs) are present, the sub-MCT gate assigned to the corresponding step may be decomposed into a CⁿNOT gate having a Toffoli-depth of 2┌log₂ n┐−1 and a T-depth of 2┌log₂ n┐+2. In the 4-2-th decomposition method, when n corresponding to the ciphertext bits of the sub-MCT gate assigned to the corresponding step is equal to or greater than 3 and when n−1 work qubits of which the initial states are known (CWQs) are present, if n is an even number, the sub-MCT gate assigned to the corresponding step may be decomposed into a CⁿNOT gate having a T-depth of 2┌log₂ n┐2┌log₂ n┐, but if n is an odd number, the sub-MCT gate assigned to the corresponding step may be decomposed into a CⁿNOT gate having a T-depth of ┌log₂ n┐+2. In the 4-3-th decomposition method, when n corresponding to the ciphertext bits of the sub-MCT gate assigned to the corresponding step is equal to or greater than 3 and when n work qubits of which the initial states are known (CWQs) are present, the sub-MCT gate assigned to the corresponding step may be decomposed into a CⁿNOT gate having a T-depth of 2┌log₂ n┐. In the 4-4-th decomposition method, when n corresponding to the ciphertext bits of the sub-MCT gate assigned to the corresponding step is equal to or greater than 3 and when n+1 work qubits of which the initial states are known (CWQs) are present, the sub-MCT gate assigned to the corresponding step may be decomposed into a CⁿNOT gate having a T-depth of 2┌log₂ n┐−1.

Here, in the fifth decomposition method, when n corresponding to ciphertext bits of a sub-MCT gate assigned to a corresponding step is equal to or greater than 4 and when a single work qubit of which the initial state is known (CWQ) and n−5 work qubits of which the initial states are unknown (DBQs) are present, the sub-MCT gate assigned to the corresponding step may be decomposed into a CⁿNOT gate having a Toffoli-depth of 4n-10 and a T-depth of 4n-5.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example of decomposing an MPMCT gate into gates of a Clifford+T set;

FIG. 2 is a view illustrating an example of decomposing a Mixed Polarity Toffoli gate, which is one of MPMCT gates, into a NOT gate or a CNOT gate;

FIG. 3 is a view illustrating an example of a Grover's algorithm implemented using an MPMCT gate;

FIG. 4 is a view illustrating the Oracle operator illustrated in FIG. 3;

FIG. 5 is a view illustrating the Diffusion operator illustrated in FIG. 3;

FIG. 6 is a flowchart illustrating a method for decomposing an MPMCT gate in a quantum circuit according to an embodiment of the present disclosure;

FIGS. 7 to 8 are views illustrating an example of decomposing an MPMCT gate by applying a first decomposition method according to the present disclosure;

FIG. 9 is a view illustrating an example of decomposing an MPMCT gate by applying a second decomposition method according to the present disclosure;

FIGS. 10 to 12 are views illustrating an example of decomposing an MPMCT gate by applying a third decomposition method according to the present disclosure;

FIG. 13 is a view illustrating an example of decomposing an MPMCT gate by applying a fourth decomposition method according to the present disclosure;

FIG. 14 is a view illustrating an example of decomposing an MPMCT gate by applying a fifth decomposition method according to the present disclosure;

FIG. 15 is a view illustrating an example in which gates of front and back steps cancel each other according to the present disclosure;

FIG. 16 is a view illustrating an example of decomposing an MPMCT gate when the number of CWQs is 2 according to the present disclosure; and

FIG. 17 is a graph illustrating the optimal T-depth depending on the number of CWQs when a C²⁵⁵NOT gate is implemented using 512 DBQs according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, conventional technology for helping understanding of the present disclosure will be described in detail.

Because operations in quantum computing are generally represented using quantum reversible circuits, various studies have been conducted on reversible circuit synthesis and optimization. Here, the design cost or execution time for the desired reversible operation is determined depending on how efficiently the quantum circuit is designed.

Generally, a reversible circuit is synthesized by implementing the same using a set of NOT, CNOT, Controlled-V, and Controlled-V† (NCV) gates or NOT, CNOT, and Toffoli (NCT) gates, after which optimization of a T-depth is performed by the process of converting or decomposing the NCV or NCT gate set into Clifford+T gates. Here, the T-depth may mean the number of times T gates are processed in a non-parallel manner in the quantum circuit.

Accordingly, in order to design an efficient quantum circuit when Fault-Tolerant Quantum Computation (FTQC) is taken into account, the circuit is synthesized so as to minimize a Toffoli-depth, which is a cost metric for a Toffoli gate that is a composite gate using T gates, and then optimization of the T-depth may be performed.

The present disclosure intends to propose a method for decomposing a composite gate called a Mixed Polarity Multiple Controlled Toffoli (MPMCT) gate.

First, the MPMCT gate may be decomposed into a set of Toffoli gates such that the Toffoli-depth is minimized. Then, the set of Toffoli gates is again decomposed into Clifford+T gates, whereby T-depth optimization is performed.

A qubit used in this process is a basic unit of quantum information, and is represented as a two-dimensional (2D) vector. Base vectors are |0> and |1>, and qubits may be in a state with any of various phases and values through a linear combination of these two base vectors.

Qubits are classified depending on the state and the purpose of use thereof in a quantum circuit, and in the present disclosure, qubits may be used by being classified into data qubits, Clean Work Qubits (CWQs), which are work qubits of which the initial states are known, and Dirty Borrowed Qubits (DBQs), which are work qubits of which the initial states are unknown.

The data qubits may correspond to qubits in which input data information is contained before a specific operation commences in a quantum circuit. For example, when a quantum circuit represented as a 4-variable reversible Boolean function is present, the number of data qubits is 4. Qubits that are not data qubits correspond to work qubits (or ancilla qubits).

The Clean Work Qubits (CWQs), which are work qubits of which the initial states are known, may assist in performing a specific operation in a quantum circuit. The initial states of the CWQs are generally set to |0>, and the CWQs are initialized again to the |0> states through an uncomputation (clearing or restoration) step after a specific operation is performed. Thanks to the uncomputation step, the CWQs in the initial states may assist in a subsequent operation.

The Dirty Borrowed Qubits (DBQs), which are work qubits of which the initial states are unknown, may be used on the assumption that they are in arbitrary states when a specific operation is designed. That is, because the DBQs are required to be restored to the original arbitrary states after assisting in a specific operation, they are not as effective as the CWQs and have a limitation in which the circuit has to be designed more complicatedly.

Also, a quantum circuit is typically represented as a two-dimensional (2D) circuit. Generally, data qubits are arranged on the upper side of the 2D circuit, and work quits are arranged on the lower side of the 2D circuit. Also, a data qubit corresponding to a Least Significant Bit (LSB) is arranged at the top, and a data qubit corresponding to a Most Significant Bit (MSB) is arranged at the bottom. The flow of time in the quantum circuit is from left to right.

Also, quantum gates forming a quantum circuit correspond to specific unitary operations, and Clifford+T gates constitute a standard fault-tolerant gate set.

Equation (1) shows representative gates of the Clifford+T gates.

$$T : \vert {x}_{1} 〉 \to {e}^{\frac{π i}{4} {x}_{1}} \vert {x}_{1} 〉 H : \vert {x}_{1} 〉 \to \frac{\vert 0 〉 + {( - 1 )}^{{x}_{1}} \vert 1 〉}{\sqrt{2}} \qquad ( 1 )$$

$$P : \vert {x}_{1} 〉 \to {e}^{\frac{π i}{2} {x}_{1}} \vert {x}_{1} 〉 X : \vert {x}_{1} 〉 \to \vert {x}_{1} ⊗ 1 〉$$

$$Z : \vert {x}_{1} 〉 \to {( - 1 )}^{{x}_{1}} \vert {x}_{1} 〉 CNOT : \vert {x}_{1} {x}_{2} 〉 \to \vert {x}_{1} ( {x}_{1} ⊕ {x}_{2} ) 〉$$

As a representative composite gate that can be formed using these gates, there is a Toffoli gate. Here, because T gates are commonly used in the Toffoli gate, a Toffoli-depth or a Toffoli-count may be used instead of a T-depth or a T-count, which are key metrics in fault-tolerant quantum computation. Here, the T-count is the number of T gates within the quantum circuit.

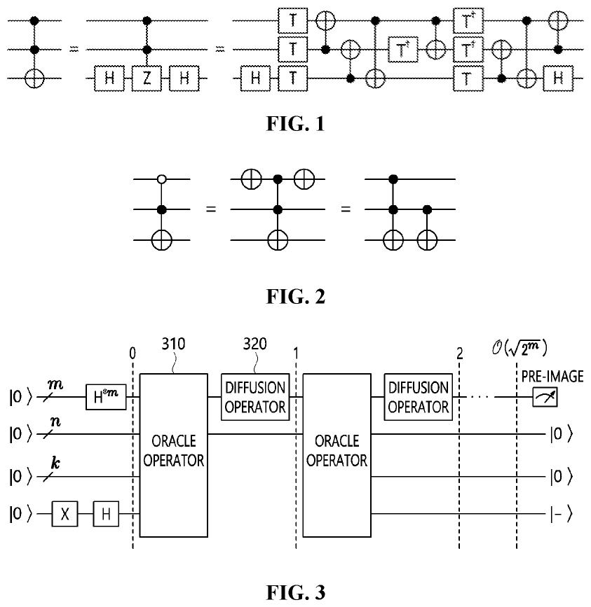

Here, the MPMCT gate T(C1, C2, t) illustrated in FIG. 1 can be seen as a generalized Toffoli gate. That is, the MPMCT gate T(C1, C2, t) is a gate in which three line sets C1, C2, and {t} are used, and bit-flip (inversion) of the state of the target line {t} occurs when all of the states of control lines included in C1 are TRUE (|1>) and when all of the states of control lines included in C2 are FALSE (|0>).

Such an MPMCT gate is also called an MCT gate or an MP-n-controlled NOT (MP-CⁿNOT) gate.

Here, an MPMCT gate may be formed by adding NOT gates or a CNOT gate to a non-MPMCT gate, as illustrated in FIG. 2. That is, a Mixed Polarity Toffoli gate, which is one of the MPMCT gates, may be decomposed into a non-MPMCT gate and NOT gates or into a non-MPMCT gate and a CNOT gate.

Hereinafter, an example of implementing an MPMCT gate used in a Grover's algorithm will be described in detail with reference to FIGS. 3 to 5.

The Grover's algorithm is an algorithm that is used for evaluating the security of a cryptosystem, and when the number of targets is 1 and when the number of data qubits is m, a Grover iteration operation is performed σ(\sqrt{2^{m}}) times, as illustrated in FIG. 3.

Here, the Grover iteration operation is configured with an Oracle operator 310 and a Diffusion operator 320.

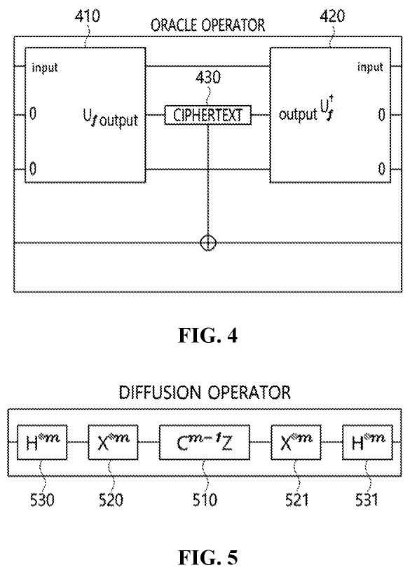

Referring to FIG. 4, the Oracle operator is configured with a quantum circuit (U_{f} 410), which implements a cryptosystem, an inverse circuit of the cryptosystem (U_{f}^{†} 420), and a comparator 430.

Here, the comparator 430 is implemented as an MPMCT gate. For example, when ciphertext is configured with n bits, this MPMCT gate is an MP-Cⁿ⁻¹NOT gate.

Referring to FIG. 5, when plaintext is configured with m bits, the Diffusion operator is configured with a C^{m-1}Z gate 510 and H gates 530 and 531 and X gates 520 and 521 surrounding the C^{m-1}Z gate.

For example, assuming that k CWQs are additionally provided, it may be expected to receive the help of at least m+k DBQs when the comparator 430 illustrated in FIG. 4 is implemented. This is because the k CWQs and the m data qubits do not maintain their initial states after they pass through the quantum circuit U_{f} 410.

In contrast, when the MPMCT gate of the Diffusion operator illustrated in FIG. 5 is implemented, it may be expected to receive the help of at least n+k CWQs.

Here, the last line illustrated in FIG. 3 represents an oracle qubit and corresponds to a work qubit for the target part of the comparator in the Grover's algorithm. However, the oracle qubit is not taken into account because it is known as being unnecessary.

Here, the optimal number of Grover iterations is derived through a previous study, and it corresponds to about 0.690×\sqrt{2^{m}}. Accordingly, in order to calculate quantum resources required for implementation of the Grover's algorithm, the derived number of Grover iterations is applied.

Hereinafter, a preferred embodiment of the present disclosure will be described in detail with reference to the accompanying drawings.

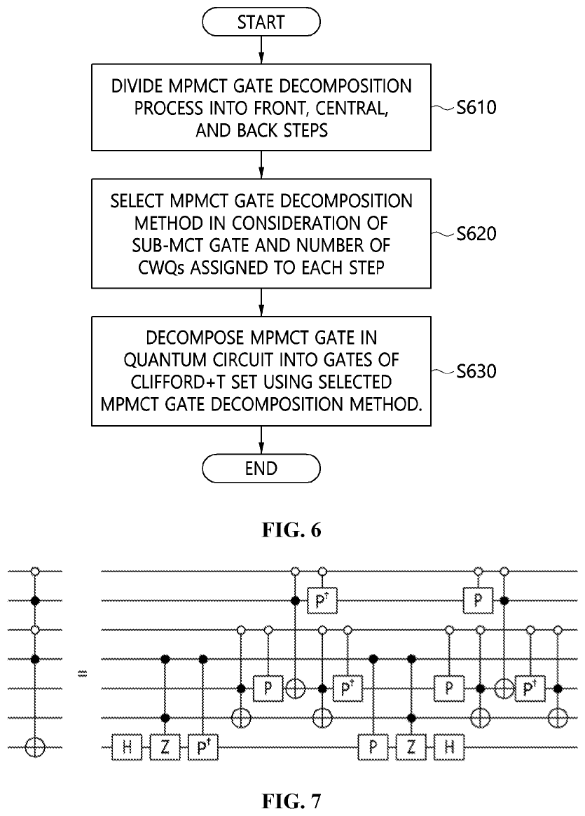

FIG. 6 is a flowchart illustrating a method for decomposing an MPMCT gate in a quantum circuit according to an embodiment of the present disclosure.

Referring to FIG. 6, in the method for decomposing an MPMCT gate in a quantum circuit according to an embodiment of the present disclosure, the process of decomposing an MPMCT gate in a quantum circuit is divided into a front step, a central step, and a back step at step S610.

Here, based on m that is the maximum number of control lines available in a sub-MCT gate assigned to the front step, c control lines used in the MPMCT gate may be divided into [c/m] or [c/m]+1 groups.

Here, in consideration of the size of the last group (C_{[c/m]} or C_{[c/m]+1}) of the groups, the sub-MCT gate to be assigned to the central group and the number of available work qubits may be determined.

Here, when the size of the last group C_{[c/m]+1} is 0, a sub-MCT gate corresponding to C^{[c/m]}NOT and k−[c/m] work qubits of which the initial states are known (CWQs) may be assigned to the central step.

Here, when the size of the last group C_{[c/m]+1} is 1, a sub-MCT gate corresponding to C^{[c/m]+1}NOT and k−[c/m] work qubits of which the initial states are known (CWQs) may be assigned to the central step.

Here, when the size of the last group C_{[c/m]+}1 is equal to or greater than 2, a sub-MCT gate corresponding to C^{[c/m]+1}NOT and k−[c/m]−1 work qubits of which the initial states are known (CWQs) may be assigned to the central step.

Here, [c/m]C^{m}NOT gates and a single C^{c-m[c/m]}NOT gate may be assigned to the front step.

Here, the front step includes multiple stages, and when the number (k) of work qubits of which the initial states are known (CWQs) is equal to or greater than 4, the front step may be designed recursively such that the value of k−[c/m]−1 is equal to or less than [c/m]+1−2 after termination of the corresponding step.

Here, the back step may be designed to be performed in the reverse order of the front step.

Here, m, which the maximum number of control lines available in the sub-MCT gate assigned to the front step, may be set equal to or less than [2c/(k−3)].

Also, in the method for decomposing an MPMCT gate in a quantum circuit according to an embodiment of the present disclosure, one of multiple decomposition methods is selected in consideration of the sub-MCT gate assigned to each of the steps and the number (k) of work qubits of which the initial states are known (CWQs) at step S620.

Here, one of the multiple decomposition methods may be selected by identifying a first case in which k, which is the number of work qubits of which the initial states are known (CWQs) is 0, a second case in which the range of k, which is the number of work qubits of which the initial states are known (CWQs), corresponds to 4≥k≥1, a third case in which the range of k, which is the number of work qubits of which the initial states are known (CWQs), corresponds to 2[c/3]≥k≥4, a fourth case in which the range of k, which is the number of work qubits of which the initial states are known (CWQs), corresponds to c−3≥k≥2[c/3], and a fifth case in which the range of k, which is the number of work qubits of which the initial states are known (CWQs), corresponds to k≥c−2.

Here, in the first case, a first decomposition method or a second decomposition method may be selected. In the second case, a third decomposition method or a fifth decomposition method may be selected. In the third case, the first decomposition method or a fourth decomposition method may be selected. In the fourth case, the fourth decomposition method may be selected. In the fifth case, the fourth decomposition method may be selected.

Here, in the first decomposition method, when n corresponding to the ciphertext bits of the sub-MCT gate assigned to the corresponding step is equal to or greater than 3 and when n−2 work qubits of which the initial states are unknown (DBQs) are present, the sub-MCT gate assigned to the corresponding step may be decomposed into a CⁿNOT gate having a Toffoli-depth of 4(n−2), a T-depth of 4(n−1), and a T-count of 12n−20.

Here, in the second decomposition method, when n corresponding to the ciphertext bits of the sub-MCT gate assigned to the corresponding step is equal to or greater than 4 and when a single work qubit of which the initial state is unknown (DBQ) is present, the sub-MCT gate assigned to the corresponding step may be decomposed into a CⁿNOT gate having a T-depth of 8n−20.

Here, the third decomposition method is divided into a 3-1-th decomposition method and a 3-2-th decomposition method depending on whether n corresponding to the ciphertext bits of the sub-MCT gate assigned to the corresponding step is an even number or an odd number. In the 3-1-th decomposition method, when n corresponding to the ciphertext bits of the sub-MCT gate assigned to the corresponding step is equal to or greater than 4 and when a single work qubit of which the initial state is known (CWQ) is present, if n is an even number, the sub-MCT gate assigned to the corresponding step may be decomposed into a CⁿNOT gate having a T-depth of 6(n−2), and in the 3-2-th decomposition method, when n corresponding to the ciphertext bits of the sub-MCT gate assigned to the corresponding step is equal to or greater than 4 and when a single work qubit of which the initial state is known (CWQ) is present, if n is an odd number, the sub-MCT gate assigned to the corresponding step may be decomposed into a CⁿNOT gate having a T-depth of 6(n−2)-2.

Here, the fourth decomposition method is divided into a 4-1-th decomposition method, a 4-2-th decomposition method, a 4-3-th decomposition method, and a 4-4-th decomposition method in consideration of the number of work qubits of which the initial states are known (CWQs) and which are assigned to the corresponding step. In the 4-1-th decomposition method, when n corresponding to the ciphertext bits of the sub-MCT gate assigned to the corresponding step is equal to or greater than 3 and when n−2 work qubits of which the initial states are known (CWQs) are present, the sub-MCT gate assigned to the corresponding step may be decomposed into a CⁿNOT gate having a Toffoli-depth of 2┌log₂ n┐−1 and a T-depth of 2┌log₂ n┐+2. In the 4-2-th decomposition method, when n corresponding to the ciphertext bits of the sub-MCT gate assigned to the corresponding step is equal to or greater than 3 and when n−1 work qubits of which the initial states are known (CWQs) are present, if n is an even number, the sub-MCT gate assigned to the corresponding step may be decomposed into a CⁿNOT gate having a T-depth of 2┌log₂ n┐2┌log₂ n┐, but if n is an odd number, the sub-MCT gate assigned to the corresponding step may be decomposed into a CⁿNOT gate having a T-depth of ┌log₂ n┐+2. In the 4-3-th decomposition method, when n corresponding to the ciphertext bits of the sub-MCT gate assigned to the corresponding step is equal to or greater than 3 and when n work qubits of which the initial states are known (CWQs) are present, the sub-MCT gate assigned to the corresponding step may be decomposed into a CⁿNOT gate having a T-depth of 2┌log₂ n┐. In the 4-4-th decomposition method, when n corresponding to the ciphertext bits of the sub-MCT gate assigned to the corresponding step is equal to or greater than 3 and when n+1 work qubits of which the initial states are known (CWQs) are present, the sub-MCT gate assigned to the corresponding step may be decomposed into a CⁿNOT gate having a T-depth of 2┌log₂ n┐−1.

Here, in the fifth decomposition method, when n corresponding to the ciphertext bits of the sub-MCT gate assigned to the corresponding step is equal to or greater than 4 and when a single work qubit of which the initial state is known (CWQ) and n−5 work qubits of which the initial states are unknown (DBQs) are present, the sub-MCT gate assigned to the corresponding step may be decomposed into a CⁿNOT gate having a Toffoli-depth of 4n−10 and a T-depth of 4n−5.

Also, in the method for decomposing an MPMCT gate in a quantum circuit according to an embodiment of the present disclosure, the MPMCT gate is decomposed into gates of a Clifford+T set, which is a standard fault-tolerant gate set, by applying the selected decomposition method at step S630.

Hereinafter, the multiple decomposition methods applied in the present disclosure will be described in detail, and the process of decomposing an MPMCT gate in the present disclosure will be described through specific embodiments.

The multiple decomposition methods to be described below have been proposed through previous studies and relate to a method of decomposing an MPMCT gate when the number of CWQs or DBQs is very large or small.

First, according to the first decomposition method, when n corresponding to ciphertext bits is equal to or greater than 3 (n≥3) and when n−2 DBQs are present in a CⁿNOT gate, the MPMCT gate may be implemented as a circuit having a Toffoli-depth of 4(n−2) and a T-depth of 4(n−1). Also, the T-count of the implemented circuit may be 12n−20.

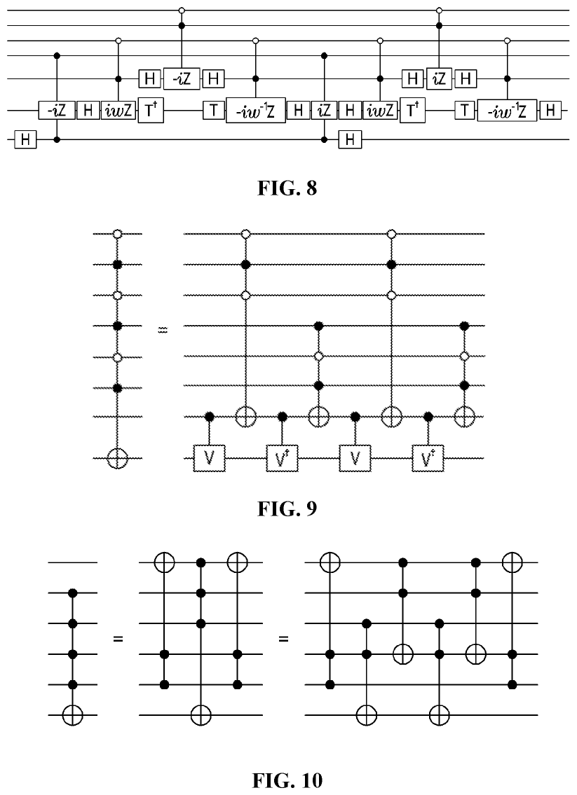

For example, FIGS. 7 to 8 illustrate an example of decomposing an MPMCT gate by applying the first decomposition method according to the present disclosure. FIGS. 7 to 8 show that an MP-C⁴NOT gate in which n is 4 (n=4) is implemented by receiving the help of two DBQs. Consequently, the MP-C⁴NOT gate may be implemented as a circuit having a Toffoli-depth of 8 and a T-depth of 12.

Also, according to the second decomposition method, when n corresponding to ciphertext bits is equal to or greater than 4 (n≥4) and when a single DBQ is present in a CⁿNOT gate, the MPMCT gate may be implemented as a circuit having a T-depth of 8n−20. Here, in order to apply the second decomposition method, two Controlled-V (CV) and Controlled-V^{†} (CV^{†}) gate pairs may be additionally used.

Also, when n is 4 (n=4), the MPMCT gate decomposed by applying the second decomposition method may be implemented as a circuit having a Toffoli-depth of 4, when n is 5 (n=5), the MPMCT gate decomposed by applying the second decomposition method may be implemented as a circuit having a Toffoli-depth of 12, and when n is equal to or greater than 6 (n≥6), the MPMCT gate decomposed by applying the second decomposition method may be implemented as a circuit having a Toffoli-depth of 8n−22.

For example, FIG. 9 illustrates an example of decomposing an MPMCT gate by applying the second decomposition method according to the present disclosure. FIG. 9 shows that two CV and CV^{†} gate pairs are used. Consequently, the C⁶NOT gate may be implemented as a circuit having a T-depth of 28.

Also, according to the third decomposition method, when n corresponding to ciphertext bits is equal to or greater than 4 (n≥4) and when a single CWQ is present in a CⁿNOT gate, if n is an even number, the MPMCT gate may be implemented as a circuit having a T-depth of 6(n−2). Also, according to the third decomposition method, when n corresponding to ciphertext bits is equal to or greater than 4 (n≥4) and when a single CWQ is present in a CⁿNOT gate, if n is an odd number, the MPMCT gate may be implemented as a circuit having a T-depth of 6(n−2)-2.

Also, when n is 4 (n=4), the MPMCT gate decomposed by applying the third decomposition method may be implemented as a circuit having a Toffoli-depth of 6, and when n is 5 (n=5), the MPMCT gate decomposed by applying the third decomposition method may be implemented as a circuit having a Toffoli-depth of 10. Also, when n is equal to or greater than 6 (n≥6) and is an even number, the MPMCT gate decomposed by applying the third decomposition method may be implemented as a circuit having a Toffoli-depth of 6n−20, and when n is equal to or greater than 6 (n≥6) and is an odd number, the MPMCT gate decomposed by applying the third decomposition method may be implemented as a circuit having a Toffoli-depth of 6n−22.

For example, FIGS. 10 to 12 illustrate an example of decomposing an MPMCT gate by applying the third decomposition method according to the present disclosure.

A C⁴NOT gate and a C⁹NOT gate are respectively implemented, and they are implemented as a circuit having a T-depth of 12 and a circuit having a T-depth of 40, respectively.

Here, as described above, an optimization task is performed on the Toffoli gates using existing T-depth reduction techniques. Referring to FIG. 10, it can be seen that the C⁴NOT gate is implemented as a circuit having a T-depth of 12 through such a task.

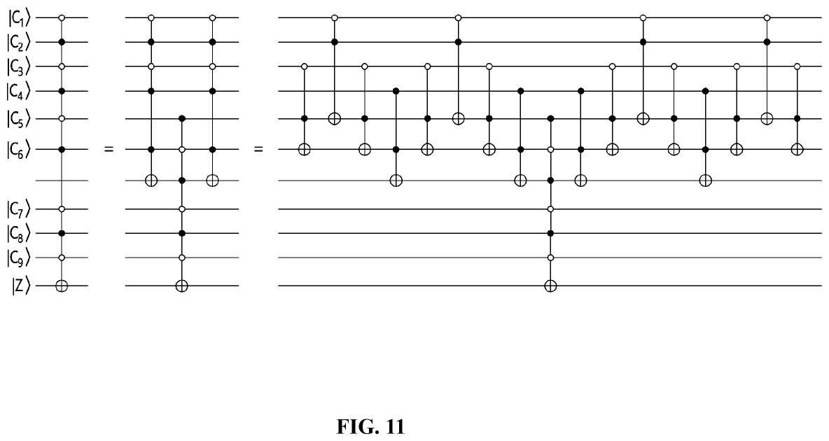

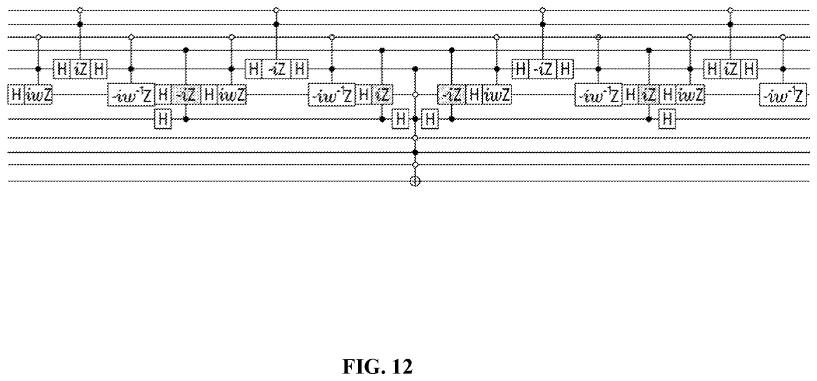

Also, referring to FIGS. 11 to 12, it can be seen that the C⁹NOT gate is decomposed into two C⁴NOT gates and a single C⁶NOT gate. The sub-MCT gates formed as the result of decomposition are decomposed into Clifford+T gates, and may then be implemented as a circuit having a T-depth of 40 using the T-depth reduction techniques.

However, in FIGS. 11 to 12, when the sub-MCT gate in the center (C⁶NOT gate) is decomposed into Toffoli gates according to the first decomposition method, it can be seen that there is a room for further reducing the T-depth. That is, the Toffoli gates forming the C⁶NOT gate and the C⁴NOT gates may be placed at the same time slice (stage).

A specific decomposition process for this case will be described in detail later through the fifth decomposition method.

Also, according to the fourth decomposition method, when n corresponding to ciphertext bits is equal to or greater than 3 (n≥3) and when n−2 CWQs are present in a CⁿNOT gate, the MPMCT gate may be implemented as a circuit having a Toffoli-depth of 2┌log₂ n┐−1 and a T-depth of 2┌log₂ n┐+2.

Also, when n−1 CWQs are present and when n is an even number, the MPMCT gate decomposed by applying the fourth decomposition method may be implemented as a circuit having a T-depth of 2┌log₂ n┐2┌log₂ n┐, and when n−1 CWQs are present and when n is an odd number, the MPMCT gate decomposed by applying the fourth decomposition method may be implemented as a circuit having a T-depth of 2┌log₂ n┐┌log₂ n┐+2. Also, when n CWQs are present, the MPMCT gate decomposed by applying the fourth decomposition method may be implemented as a circuit having a T-depth of 2┌log₂ n┐, and when n+1 CWQs are present, the MPMCT gate decomposed by applying the fourth decomposition method may be implemented as a circuit having a T-depth of 2┌log₂ n┐−1.

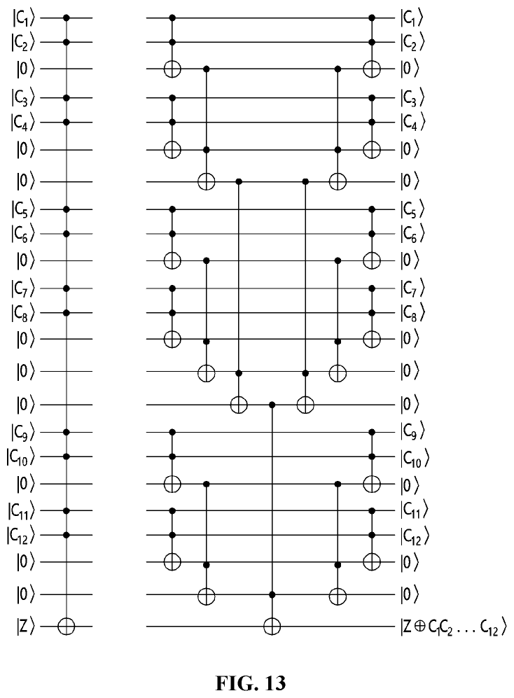

Here, the fourth decomposition method is a method that can be used when there is a sufficient number of CWQs, and FIG. 13 illustrates an example of decomposing an MPMCT gate by applying the fourth decomposition method according to the present disclosure. For example, referring to FIG. 13, it can be seen that 10 CWQs are used in order to implement the C¹²NOT gate as a circuit having a Toffoli-depth of 7 and a T-depth of 10.

Also, according to the fifth decomposition method, when n corresponding to ciphertext bits is equal to or greater than 4 (n≥4) and when a single CWQ and n−5 DBQs are present in a CⁿNOT gate, the MPMCT gate may be implemented as a circuit having a T-depth of 4n−5 and a Toffoli-depth of 4n−10. Surely, DBQs are not necessary when n is 4 (n=4).

Here, when the fifth decomposition method is applied, a CⁿNOT gate may be decomposed into two Toffoli gates and a Cⁿ⁻¹NOT gate.

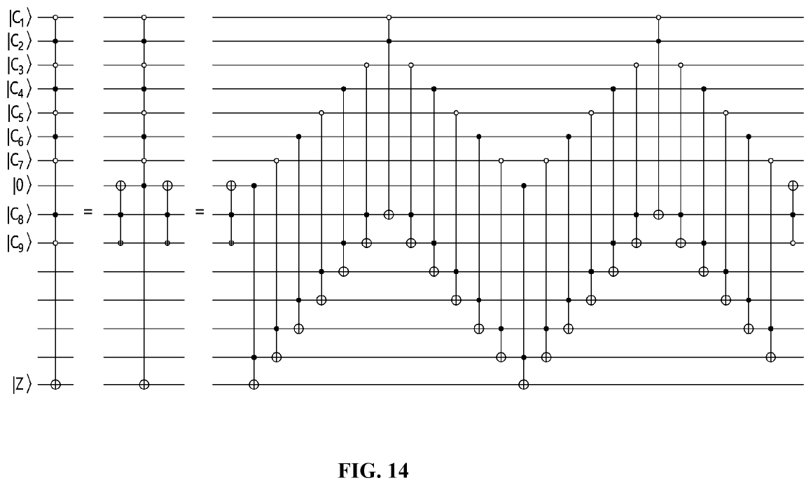

For example, FIG. 14 illustrates an example of decomposing an MPMCT gate by applying the fifth decomposition method according to the present disclosure and illustrates an example of using a C⁹NOT gate.

Referring to FIG. 14, it can be seen that the C⁸NOT gate in the center is decomposed into 24 Toffoli gates through the first decomposition method.

In Table 1, the above-described first to fifth decomposition methods (Lemma1 to Lemma5) are summarized.

TABLE 1

| | #control | #CWQ | #DBQ | T-depth | Toffoli-depth | Remark |
|---|---|---|---|---|---|---|
| Lemma 1 | c ≥ 3 | 0 | c − 2 | 4c − 4 | 4c − 8 | |
| [5, 6, 9, 15] | | | | | | |
| Lemma 2 | c ≥ 4 | 0 | 1 | 8c − 20 | 8c − 32 for c ≥ 6 | CV/CV^{†} pairs |
| [5, 6] | | | | | | are used |
| Lemma 3 | c ≥ 4 | 1 | 0 | 6c − 12(−2) | 6c − 20(−2) for | |
| [5, 6, 9] | | | | | c ≥ 4 | |
| Lemma 4 | c ≥ 3 | c − 2 | 0 | 2[log₂c] + 2 | 2[log₂c] − 1 | |
| [4, 19, 6] | | | | | | |
| Lemma 5 | c ≥ 4 | 1 | c − 5 | 4c − 5 | 4c − 10 | |

Referring to Table 1, it can be seen that, when there is a sufficient number of CWQs, the Toffoli-depth can be represented as a logarithm expression, rather than a linear expression.

Hereinafter, a process of decomposing an MPMCT gate by selectively using the multiple decomposition techniques in the present disclosure will be described through specific embodiments.

First, the number of control lines, the number of CWQs, and the number of DBQs in an MPMCT gate are denoted by c, k, and d, respectively, and the i-th CWQ is denoted by aᵢ (i=1, . . . , k).

Conventional methods typically use CWQs in the front and back steps and use DBQs in the central step, but the present disclosure proposes a method for suitably using all of the CWQs and the DBQs across the entire circuit.

The key idea is to roughly match the number of control lines of the sub-MCT gate to be handled in the central step and the number of remaining CWQs. When they are made to match each other, the fourth decomposition method may be applied in the central step.

For example, it may be assumed that a C^{C}NOT gate is designed.

Here, when the largest number of control lines in the sub-MCT gates used in the front step is m, the c control lines of the MPMCT gate may be divided into [c/m]+1 groups C₁, C₂, . . . , C_{[c/m]+1}. Here, the sizes of the respective groups may be set to |C₁|= . . . =|C_{[c/m]}|=m, and |C_{[c/m]+1}=c-m[c/m]. That is, the size of each of the groups, excluding the last group, is m, and the size of the last group may correspond to a value acquired by subtracting the sum of the sizes of the preceding groups from c.

Here, [c/m] CWQs may be used as the target parts of the [c/m] sub-MCT gates. If |C_{[c/m]+1}| is equal to or greater than 2, one CWQ may be additionally used.

Table 2 illustrates the sub-MCT gate to be handled in the central step and the number of remaining CWQs depending on the size of the last group C_{[c/m]+1} in the front step.

TABLE 2

| \|C_{[c/m]+1}\| | Sub MCT gate in central step | Remaining #CWQ |
|---|---|---|
| 0 | C^{[c/m]}NOT | k − [c/m] |
| 1 | C^{[c/m]+1}NOT | k − [c/m] |
| 2 | C^{[c/m]+1}NOT | k − [c/m] − 1 |

That is, referring to Table 2, it is necessary to decompose the C^{[c/m]}NOT or the C^{[c/m]+1}NOT using the remaining k−[c/m] or k−[c/m]−1 CWQs in the central step.

When k−[c/m]−1≥[c/m]+1−2 is satisfied, the fourth decomposition method may be applied in the central step.

Also, in the front step, it is necessary to decompose [c/m]C^{m}NOT gates and a single C^{c-m[c/m]}NOT gate into Toffoli gates. Here, when [c/m](m−2)+(c-m[c/m])−2 DBQs are present, the first decomposition method may be applied.

Here, each of the front step, the central step, and the back step according to the present disclosure may be configured with multiple stages (time slices).

Here, the back step may be designed to be performed in the reverse order of the front step.

When the above-described method is used, the MPMCT gate may be decomposed into a circuit having a Toffoli-depth of about 4(m−2)×2+2┌log₂[c/m]┐−1.

Here, what is required is to determine m, which is the number of control lines of the sub-MCT gate in the front step and the back step.

First, in order to apply the fourth decomposition method to the central step and to obtain the optimal T-depth, the condition k−[c/m]−1≤[c/m]+1−2 has to be satisfied. If the corresponding condition is not satisfied, the number of remaining CWQs is excessively large, which results in implementation of an inefficient circuit.

Through the above-condition, m, which is the number of control lines of the sub-MCT gate in the front and back steps, may be selected as a value corresponding to m≤[2c/(k−3)].

Here, because each step can be configured with multiple stages, different values may be selected as m in each of the stages.

Accordingly, among all of the circuits acquired through iterative learning based on all of the values of m satisfying m≤[2c/(k−3)], the circuit having the smallest Toffoli-depth (that is, the smallest T-depth) may be selected.

Hereinafter, an embodiment of gate decomposition performed when the number of CWQs (k) is equal to or greater than 4 in an MPMCT gate will be described in detail. Here, the following process may be repeated until m becomes 2 from min{[2c/(k−3)], c−1}.

First, for given m, whether the conditions corresponding to k≥[c/m](+1) and d≥[c/m](m−2)+(c−m[c/m])−2 are satisfied is checked. When the conditions are not satisfied, m decreases by 1, and whether the conditions are satisfied may be checked again. When the conditions are satisfied, the control lines of the given MPMCT gate are divided into [c/m]+2 sets. As described above, [c/m]C^{m}NOT gates and a single C^{c-m[c/m]}NOT gate may be arranged in the front step. Accordingly, in the central step, the C^{[c/m](+1)}NOT gate may be decomposed using the remaining k−[c/m](−1) CWQs by applying the fourth decomposition method. If CWQs and DBQs are sufficient, further reducing the Toffoli-depth and the T-depth may be attempted in the front step or the back step. The Toffoli-depth and the T-depth of the designed circuit may be recorded.

When the number of remaining CWQs is less than the number of control lines of the sub-MCT gate to be handled in the central step and when the difference is equal to or greater than 4, the fourth decomposition method cannot be applied in the central step. In this case, the front step may be recursively performed. That is, the front step configured with multiple stages may be performed multiple times such that the fourth decomposition method can be applied in the central step. Likewise, the back step may be performed in the reverse order of the front step.

Here, when the Toffoli-depth and the T-depth are recorded in a list by repeating the process while decreasing the value of m, both the Toffoli-depth and the T-depth may increase at some point. In this case, the process is terminated, and the MPMCT gate may be decomposed by selecting the decomposition method having the smallest T-depth, among the values recorded in the list.

The reason for checking all possible cases while reducing the value of m to 2 as described above is for making the technique have completeness and including the results of the previous studies in the list. That is, as m decreases, the recorded T-depth/Toffoli-depth values also decrease, but they increase at some point, and in this case, the optimal T-depth value is already included in the list, so the repetitive process may be terminated.

Here, after the front step is terminated, when the number of remaining CWQs is less than the number of control lines of the sub-MCT gate to be handled and when the difference is equal to or greater than 4, the fourth decomposition method cannot be applied in the central step, and it is necessary to recursively perform the front step as described above.

Also, when a sufficient number of CWQs or DBQs is present, it is necessary to check whether the Toffoli-depth can be further reduced in the front step and the back step.

Hereinafter, a decomposition process performed when there is a sufficient number of CWQs or DBQs will be described in detail.

First, when there is a sufficient number of CWQs, whether the fourth decomposition method can be applied to the front step and the back step may be checked. For example, when q C^{m}NOT gates are installed in the front step, if q(m−2) CWQs are present, the corresponding sub-MCT gates may be implemented as a circuit having a Toffoli-depth of 2┌log₂ m┐−1.

In contrast, when there is a sufficient number of DBQs, the gates in the front and back steps cancel each other, whereby the Toffoli-depth/T-depth may be further reduced. For example, when q(m−2) DBQs are present, the first decomposition method may be applied in the front step and the back step (the same decomposition method is applied to stages corresponding to each other in the front and back steps). If DBQs used in one stage are not used in other stages, the Toffoli gates in the front step and the back step may cancel each other. That is, the Toffoli-depth may be reduced from 2×4(m−2) to 2×(2m−3) in the front/back steps.

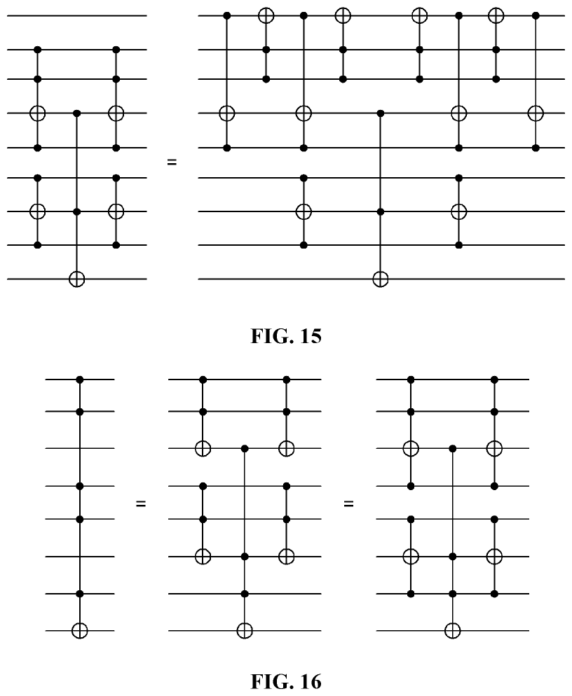

Here, FIG. 15 illustrates an example in which gates of the front and back steps cancel each other according to the present disclosure, and the two Toffoli gates located in the center may cancel each other because they are adjacent to each other without an intervening gate.

However, when the number of CWQs (k) is less than 4, the conditional equation m=[2c/(k−3)] cannot be used. In this case, decomposition of the MPMCT gate may be attempted through the method to be described below.

First, when k is 2, it may be assumed that all of the two CWQs are used in the front step and the back step, in which case the value of m should satisfy m≤c/2. Accordingly, when k is 2, the above process may be performed to correspond to 2≤m≤c/2.

For example, FIG. 16 illustrates an example of decomposing an MPMCT gate when the number of CWQs is 2 according to the present disclosure, and illustrates the process of decomposing a C⁵NOT gate using the two CWQs. Referring to FIG. 16, because [c/2] is 3 ([c/2]=3), decomposition may be attempted for each of the case in which m is 3 and the case in which m is 2. Referring to FIG. 16, it can be seen that, when m is 3, the C⁵NOT gate may be implemented as a circuit having a Toffoli-depth of 7 and a T-depth of 12. For reference, the target qubit of the C⁵NOT gate may also be used as a DBQ in the front step and the back step.

Also, when k is 3, the condition may be relaxed to have the optimal Toffoli-depth, rather than the optimal T-depth, in the central step. That is, using k−[c/m]−1≤[c/m]+1−2, the value of m≤[2c/k] is obtained, and the above process may be performed to correspond to 2≤m≤[2c/3].

For example, when a C⁶NOT gate is decomposed using three CWQs and two DBQs, because k is 3, the circuit may be implemented for the respective cases in which m is 4, 3, and 2. Consequently, it can be seen that, when m is 2, the C⁶NOT gate can be implemented as a circuit having a Toffoli-depth of 6 and a T-depth of 11.

Table 3 illustrates the examples according to the present disclosure.

TABLE 3

| #control | #CWQ | #DBQ | T-depth | Toffoli-Depth | Remark |
|---|---|---|---|---|---|
| 4 | 0 | 2 | 12 | 8 | Lemma 1 |
| 6 | 0 | 1 | 28 | 16 | Lemma 2 |
| 4 | 1 | 0 | 12 | 6 | Lemma 3 |
| 9 | 1 | 0 | 40 | 32 | Lemma 3 |
| 12 | 10 | 0 | 10 | 7 | Lemma 4 |
| 9 | 1 | 4 | 31 | 26 | Lemma 5 |
| 5 | 2 | 0 or 1 | 12 | 7 | Proposed method |
| 6 | 3 | 2 | 11 | 6 | Proposed method |

In the present disclosure, the MPMCT decomposition process may be performed by being broadly divided into five categories depending on the number of CWQs (k). If k is near the boundary value of each section, all of the relevant categories may be considered.

First, in the first case in which k is 0, there is no available CWQ, so decomposing the MPMCT gate may be attempted using the first decomposition method or the second decomposition method. If the number of DBQs is less than c−2 and is greater than 1, the method using only DBQs, among the previous methods, may be considered.

Also, in the second case in which the range of k corresponds to 4Ãk≥1, decomposing the MPMCT gate may be attempted using the third decomposition method or the fifth decomposition method. Here, because the number of CWQs is small, the ranges of m mentioned in the example of Table 3 may be used. If there is a sufficient number of DBQs, whether the Toffoli-depth can be further reduced in the front step and the back step may be considered. Also, the method using only DBQs, among the previous studies, may be considered.

Also, the third case in which the range of k corresponds to 2[c/3]Ãk≥4 is a section in which an expression corresponding to m≤2c/(k−3) can be used. Generally, the optimal circuit is obtained near m=2c/(k−3), but when the number of CWQs is small, the optimal circuit may be implemented by recursively repeating the decomposition method. In some cases, a circuit having the optimal Toffoli-depth may be returned when not the fourth decomposition method but the first decomposition method is applied in the central step.

Also, in the fourth case in which the range of k corresponds to c−3Ãk≥2[c/3], C³NOT gates may be used as sub-MCT gates in the front and back steps. That is, each step does not have to be configured with multiple stages, and because there is a sufficient number of CWQs, the fourth decomposition method may be applied in not only the central step but also the front and back steps. This section may be a section in which the Toffoli-depth and the T-depth remain constant even though k increases.

Also, in the fifth case in which the range of k corresponds to k≥c−2, the MPMCT gate may be decomposed by applying the fourth decomposition method.

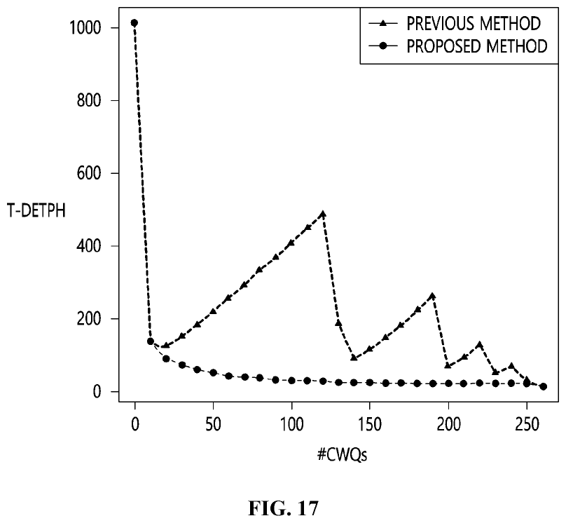

Here, FIG. 17 is for comparing the result of one of the previous studies with the result according to the present disclosure, and is a graph illustrating the optimal T-depth depending on the number of CWQs when a C²⁵⁵NOT gate is implemented using 512 DBQs.

Referring to FIG. 17, superiority of the method proposed in the present disclosure over the previous method can be confirmed.

Also, it can be seen that a logical error occurs when the previous method is used. This is because the previous method tends to use an excessive number of CWQs in the front and back steps and a large number of DBQs in the central step when the MPMCT gate is decomposed.

In contrast, the method proposed in the present disclosure suitably uses both CWQs and DBQs across all of the parts of the circuit.

When the MPMCT gate required for the Grover's algorithm is implemented using the method described in the present disclosure, it may be represented as shown in Table 4.

Here, the used cryptosystem corresponds to SHA-256 (SHA-Z1, SHA-Z2, SHA-Z3, and SHA-Z4) and SHA3-256 (SHA3-256-v1, SHA3-256-v2, and SHA3-256-v3).

Referring to Table 4, it can be seen that the number of control lines of the MPMCT gate that has to be implemented in the Diffusion operator varies depending on the length of a message.

For example, when the length of a message is 266 (|M|=266), a C²⁶⁵NOT gate has to be implemented, and when IM=447 is satisfied, a C⁴⁴⁶NOT gate has to be implemented. Also, when the length of a message is 1086 bits, a C¹⁰⁸⁵NOT gate has to be implemented. Here, 447 may correspond to the maximum length of the original message that can be handled in a single message block of SHA-256, and 1086 may correspond to the maximum length of the original message that can be handled in a single message block of SHA3-256.

TABLE 4

| Secure Hash | Grover's | | | | | Toffoli-depth(T-depth) | |
|---|---|---|---|---|---|---|---|
| Algorithm | Algorithm | \|M\| | #controls | #CWQ | #DBQ | Previous method | Proposed method |
| SHA-Z1, Z2, | Diffusion | 266 | 265 | 5021 | 0 | 17(17) | 17(17) |
| Z3, Z4 | operator | | | | | | |
| SHA-Z1 | Diffusion | 447 | 446 | 321 | 0 | 394(408) | 21(27) |
| | operator | | | | | | |
| SHA-Z2 | Diffusion | 447 | 446 | 350 | 0 | 100(114) | 21(27) |
| | operator | | | | | | |
| SHA-Z3, Z4 | Diffusion | 447 | 446 | 4801 | 0 | 17(17) | 17(17) |
| | operator | | | | | | |
| SHA-Z1 | Oracle | — | 255 | 0 | 512 | 1012(1016) | 1012(1016) |
| | operator | | | | | | |
| SHA-Z2 | Oracle | — | 255 | 29 | 512 | 164(176) | 61(74) |
| | operator | | | | | | |
| SHA-Z3 | Oracle | — | 255 | 159 | 512 | 138(152) | 21(27) |
| | operator | | | | | | |
| SHA-Z4 | Oracle | — | 255 | 194 | 512 | 164(178) | 19(25) |
| | operator | | | | | | |
| SHA3-256- | Diffusion | 266 | 265 | 13341 | 0 | 17(17) | 17(17) |
| v1, v2, v3, | operator | | | | | | |
| v4 | | | | | | | |
| SHA3-256- | Diffusion | 1086 | 1085 | 514 | 0 | 2056(2068) | 39(47) |
| v1 | operator | | | | | | |
| SHA3-256- | Diffusion | 1086 | 1085 | 11541 | 0 | 21(21) | 21(21) |
| v2, v3, v4 | operator | | | | | | |
| SHA3-256- | Oracle | — | 255 | 0 | 1344 | 1012(1016) | 1012(1016) |
| v1 | operator | | | | | | |
| SHA3-256- | Oracle | — | 255 | 6401 | 1344 | 15(15) | 15(15) |
| v2, v3, v4 | operator | | | | | | |

Here, because the length of ciphertext is 256 in both the SHA-256 algorithm and the SHA3-256 algorithm, a C²⁵⁵NOT gate has to be implemented in the Oracle operator.

Here, quantum resources (Toffoli-depth and T-depth) for the MPMCT gate required in each operator may be confirmed through Table 4. Also, it can be seen that the numbers of CWQs and DBQs vary depending on the given cryptosystem circuit, and the difference between the result of the previous method and the result of the proposed method may be confirmed.

Here, when there is a sufficient number of CWQs or DBQs, there is no difference between the result of the previous method and the result of the proposed method because the first decomposition method or the fourth decomposition method is used. However, it can be seen that the Toffoli-depth (T-depth) is reduced more rapidly in the proposed method.

Table 5 illustrates quantum resources (Width (the total number of qubits), Toffoli-depth, and T-depth) required for implementing the Grover's algorithm using the MPMCT gate formed according to Table 4.

TABLE 5

| | | Toffoli-depth for | Toffoli-depth |
|---|---|---|---|
| Secure Hash | | Secure Hash | for Grover's |
| Algorithm | Width | Algorithm | Algorithm |
| SHA-Z1 | 768 | 32895 | 1.4070 . . . ^{×} 2¹⁴³ |
| SHA-Z2 | 797 | 12023 | 1.0160 . . . ^{×} 2¹⁴² |
| SHA-Z3 | 927 | 6914 | 1.1679 . . . ^{×} 2¹⁴¹ |
| SHA-Z4 | 962 | 4418 | 1.4946 . . . ^{×} 2¹⁴⁰ |
| SHA3-256-v1 | 1600 | 168 | 1.8396 . . . ^{×} 2¹³⁷ |
| SHA3-256-v2 | 2240 | 144 | 1.7245 . . . ^{×} 2¹³⁵ |
| SHA3-256-v3, v4 | 4800 | 96 | 1.2075 . . . ^{×} 2¹³⁵ |

Here, because the Grover iteration has to be repeatedly performed about 0.690×\sqrt{2^{m}} times as described above, the Toffoli-depth of the Grover's algorithm may be represented as an exponential expression, as shown in Table 5.

According to the present disclosure, work qubits are provided in a balanced way across an entire quantum circuit, whereby an efficient quantum circuit based on MPMCT gates may be implemented.

Also, the present disclosure may minimize a time cost metric corresponding to a T-depth (Toffoli-depth) in consideration of Fault-Tolerant Quantum Computation (FTQC).

Also, the present disclosure efficiently decomposes an MPMCT gate, which is used in various quantum algorithms, thereby more efficiently implementing a quantum algorithm.

As described above, the method for decomposing an MPMCT gate in a quantum circuit according to the present disclosure is not limitedly applied to the configurations and operations of the above-described embodiments, but all or some of the embodiments may be selectively combined and configured, so the embodiments may be modified in various ways.

What is claimed is:

1. A method for decomposing a Mixed Polarity Multiple Controlled Toffoli (MPMCT) gate in a quantum circuit, comprising:
dividing a process of decomposing an MPMCT gate in a quantum circuit into a front step, a central step, and a back step;
selecting one of multiple decomposition methods in consideration of a sub-MCT gate assigned to each of the steps and a number (k) of work qubits of which initial states are known (Clean Work Qubits (CWQs)); and
decomposing the MPMCT gate into gates of a Clifford+T set, which is a standard fault-tolerant gate set, by applying the selected decomposition method.

2. The method of claim 1, wherein dividing the process includes based on m that is a maximum number of control lines available in the sub-MCT gate assigned to the front step, dividing c control lines used in the MPMCT gate into [c/m] or [c/m]+1 groups; and
setting the sub-MCT gate assigned to the central step and a number of available work qubits in consideration of a size of a last group (C_{[c/m]} or C_{[c/m]+1}) of the groups.

3. The method of claim 2, wherein, when the size of the last group (C_{[c/m]+1}) is 0, a sub-MCT gate corresponding to C^{[c/m]}NOT and k−[c/m] work qubits of which the initial states are known (CWQs) are assigned to the central step.

4. The method of claim 2, wherein, when the size of the last group (C_{[c/m]+1}) is 1, a sub-MCT gate corresponding to C^{[c/m]+1}NOT and k−[c/m] work qubits of which the initial states are known (CWQs) are assigned to the central step.

5. The method of claim 2, wherein, when the size of the last group (C^{[c/m]+1}) is equal to or greater than 2, a sub-MCT gate corresponding to C_{[c/m]+1}NOT and k−[c/m]−1 work qubits of which the initial states are known (CWQs) are assigned to the central step.

6. The method of claim 2, wherein dividing the process comprises assigning [c/m]C^{m}NOT gates and a single C^{c-m[c/m]}NOT gate to the front step.

7. The method of claim 2, wherein the front step includes multiple stages and is designed recursively such that a value of k−[c/m]−1 becomes equal to or less than [c/m]+1-2 after termination of the corresponding step when the number (k) of work qubits of which the initial states are known (CWQs) is equal to or greater than 4.

8. The method of claim 7, wherein the back step is designed to be performed in a reverse order of the front step.

9. The method of claim 2, wherein m, which is the maximum number of control lines available in the sub-MCT gate assigned to the front step, is set equal to or less than ┌2c/(k−3)┐.

10. The method of claim 2, wherein selecting one of the multiple decomposition methods comprises selecting one of the multiple decomposition methods by identifying a first case in which the number (k) of work qubits of which the initial states are known (CWQs) is 0, a second case in which a range of the number (k) of work qubits of which the initial states are known (CWQs) corresponds to 4≥k≥1, a third case in which the range of the number (k) of work qubits of which the initial states are known (CWQs) corresponds to 2[c/3]≥k≥4, a fourth case in which the range of the number (k) of work qubits of which the initial states are known (CWQs) corresponds to c−3≥k≥2[c/3], and a fifth case in which the range of the number (k) of work qubits of which the initial states are known (CWQs) corresponds to k≥c−2.

11. The method of claim 10, wherein selecting one of the multiple decomposition methods comprises selecting a first decomposition method or a second decomposition method in the first case, selecting a third decomposition method or a fifth decomposition method in the second case, selecting the first decomposition method or a fourth decomposition method in the third case, selecting the fourth decomposition method in the fourth case, and selecting the fourth decomposition method in the fifth case.

12. The method of claim 11, wherein, in the first decomposition method, when n corresponding to ciphertext bits of a sub-MCT gate assigned to a corresponding step is equal to or greater than 3 and when n−2 work qubits of which initial states are unknown (Dirty Borrowed Qubits (DBQs)) are present, the sub-MCT gate assigned to the corresponding step is decomposed into a CⁿNOT gate having a Toffoli-depth of 4(n−2), a T-depth of 4(n−1), and a T-count of 12n−20.

13. The method of claim 11, wherein, in the second decomposition method, when n corresponding to ciphertext bits of a sub-MCT gate assigned to a corresponding step is equal to or greater than 4 and when a single work qubit of which an initial state is unknown (Dirty Borrowed Qubits (DBQ)) is present, the sub-MCT gate assigned to the corresponding step is decomposed into a CⁿNOT gate having a T-depth of 8n−20.

14. The method of claim 11, wherein
the third decomposition method is divided into a 3-1-th decomposition method and a 3-2-th decomposition method depending on whether n corresponding to ciphertext bits of a sub-MCT gate assigned to a corresponding step is an even number or an odd number,
in the 3-1-th decomposition method, when n corresponding to the ciphertext bits of the sub-MCT gate assigned to the corresponding step is equal to or greater than 4 and when a single work qubit of which an initial state is known (CWQ) is present, if n is an even number, the sub-MCT gate assigned to the corresponding step is decomposed into a CⁿNOT gate having a T-depth of 6(n−2), and
in the 3-2-th decomposition method, when n corresponding to the ciphertext bits of the sub-MCT gate assigned to the corresponding step is equal to or greater than 4 and when a single work qubit of which the initial state is known (CWQ) is present, if n is an odd number, the sub-MCT gate assigned to the corresponding step is decomposed into a CⁿNOT gate having a T-depth of 6(n−2)-2.

15. The method of claim 11, wherein
the fourth decomposition method is divided into a 4-1-th decomposition method, a 4-2-th decomposition method, a 4-3-th decomposition method, and a 4-4-th decomposition method in consideration of the number of work qubits of which the initial states are known (CWQs) and which are assigned to a corresponding step,
in the 4-1-th decomposition method, when n corresponding to ciphertext bits of a sub-MCT gate assigned to the corresponding step is equal to or greater than 3 and when n−2 work qubits of which the initial states are known (CWQs) are present, the sub-MCT gate assigned to the corresponding step is decomposed into a CⁿNOT gate having a Toffoli-depth of 2┌log₂ n┐−1 and a T-depth of 2┌log₂ n┐+2,
in the 4-2-th decomposition method, when n corresponding to the ciphertext bits of the sub-MCT gate assigned to the corresponding step is equal to or greater than 3 and when n−1 work qubits of which the initial states are known (CWQs) are present, if n is an even number, the sub-MCT gate assigned to the corresponding step is decomposed into a CⁿNOT gate having a T-depth of 2┌log₂ n┐2┌log₂ n┐, but if n is an odd number, the sub-MCT gate assigned to the corresponding step is decomposed into a CⁿNOT gate having a T-depth of ┌log₂ n┐+2,
in the 4-3-th decomposition method, when n corresponding to the ciphertext bits of the sub-MCT gate assigned to the corresponding step is equal to or greater than 3 and when n work qubits of which the initial states are known (CWQs) are present, the sub-MCT gate assigned to the corresponding step is decomposed into a CⁿNOT gate having a T-depth of 2┌log₂ n┐, and
in the 4-4-th decomposition method, when n corresponding to the ciphertext bits of the sub-MCT gate assigned to the corresponding step is equal to or greater than 3 and when n+1 work qubits of which the initial states are known (CWQs) are present, the sub-MCT gate assigned to the corresponding step is decomposed into a CⁿNOT gate having a T-depth of 2┌log₂ n┐−1.

16. The method of claim 11, wherein in the fifth decomposition method, when n corresponding to ciphertext bits of a sub-MCT gate assigned to a corresponding step is equal to or greater than 4 and when a single work qubit of which an initial state is known (CWQ) and n−5 work qubits of which initial states of which are unknown (Dirty Borrowed Qubits (DBQs)) are present, the sub-MCT gate assigned to the corresponding step is decomposed into a CⁿNOT gate having a Toffoli-depth of 4n−10 and a T-depth of 4n−5.
